(19) United States
(12) Patent Application Publication
(10) Pub. No.: US 2008/0049140 A1
(43) Pub. Date: Feb. 28, 2008

(54) Apparatus for recovering SECAM chrominance signal and method thereof

(75) Inventors: Hyo-Ju Kim, Yongin-si (KR); Seong-Wen Lee, Seongnam-si (KR); Do-Gyun Kim, Seoul (KR); Yun-Sung Wang, Seoul (KR); Ji-Hoon Jang, Younin-si (KR)

Correspondence Address: NIXON & VANDERHYE, PC, 901 NORTH GLEBE ROAD, 11TH FLOOR, ARLINGTON, VA, 22203, US

(73) Assignee: NEXTCHIP CO., LTD., Seoul (KR)

(21) Appl. No.: 11/889,929

(22) Filed: Aug. 17, 2007

(30) Foreign Application Priority Data
Aug. 23, 2006 (KR) 10-2006-0080055

(51) Int. Cl. H04N 3/27

(52) U.S. Cl. 348/554; 348/E03.049

(57) ABSTRACT

An apparatus for recovering a chrominance signal from a sequential color with memory (SECAM) composite video baseband signal (CVBS), and more particularly, an apparatus and method of recovering a SECAM chrominance signal to simplify a circuit configuration of a frequency demodulator since a phase different calculation scheme is simplified is provided. The apparatus for recovering a chrominance signal from a CVBS includes: a frequency demodulator calculating a phase difference between neighboring samples by using an arctangent approximation from an input signal; and a direct current (DC) compensation unit eliminating a DC offset from the calculated phase difference, wherein the phase difference corresponds to the chrominance signal.

### CROSS-REFERENCE TO RELATED APPLICATION

This application claims the benefit of Korean Patent Application No. 10-2006-0080055, filed on Aug. 23, 2006, in the Korean Intellectual Property Office, the disclosure of which is incorporated herein by reference.

### BACKGROUND OF THE INVENTION

1. Field of the Invention

The present invention relates to an apparatus for recovering a chrominance signal from a sequential color with memory (SECAM) composite video baseband signal (CVBS), and more particular, to an apparatus and method of recovering a SECAM chrominance signal to simply a circuit configuration of a frequency demodulator since a phase different calculation scheme is simplified.

2. Description of Related Art

Generally, a composite video baseband signal (CVBS) is generated by synthesizing a video signal, a synchronizing signal, and the like, into a single signal. In this instance, the video signal contains encoding information which is needed to form video, and the synchronizing signal indicates display timing on a screen. Standards of the CVBS include National Television System Committee (NTSC), Phase Alternating Line (PAL), sequential color with memory (SECAM), and the like.

SECAM is a standard which was developed in France and was first used in broadcasting in the year 1967. Also, while NTSC and PAL utilize an amplitude modulation (AM) scheme for the color signal modulation technique, SECAM utilizes a frequency modulation (FM) scheme for a color signal modulation scheme.

SECAM constructs one scene with 625 scanning lines, transmits 25 scenes per second, and transmits 50 fields at the interlaced scanning of 2:1. Also, the bandwidth of D_{R} and D_{B} corresponding to chrominance signal components is limited to about 1.3 MHz. In order to prevent mutual interference between the chrominance signal components D_{R} and D_{B} when transmitting a frequency-modulated chrominance signal component, SECAM alternatively transmits the chrominance signal components D_{R} and D_{B} every time a scanning line is changed.

An apparatus for recovering a chrominance signal from a CVBS, which is transmitted by a SECAM scheme, needs to calculate an arctangent in order to calculate a phase difference via a frequency demodulator. Schemes of approximating an arctangent function include various types of schemes, for example, a scheme of utilizing a Coordinate Rotation Digital Computer (CORDIC), a scheme of utilizing a lookup table, and the like.

However, in a conventional art, an apparatus for recovering a SECAM CVBS approximates an arctangent function using a CORDIC or a lookup table to calculate a phase difference using a frequency demodulator. Accordingly, a process of calculating the phase difference is complex, which results in complicating a circuit configuration of the frequency demodulator.

### BRIEF SUMMARY

An aspect of the present invention provides an apparatus and method of recovering a sequential color with memory (SECAM) chrominance signal which can utilize both a real number portion and an imaginary number portion to recover a chrominance signal, and calculate a phase difference using an arctangent approximation and thus can simplify a phase difference calculation scheme and also simplify a circuit configuration of a frequency demodulator.

According to an aspect of the present invention, there is provided an apparatus for recovering a chrominance signal from a composite video baseband signal (CVBS), the apparatus including: a frequency demodulator calculating a phase difference between neighboring samples by using an arctangent approximation from an input signal; and a direct current (DC) compensation unit eliminating a DC offset from the calculated phase difference, wherein the phase difference corresponds to the chrominance signal.

According to another aspect of the present invention, there is provided a method of recovering a chrominance signal from a CVBS, the method including: calculating a phase difference between neighboring samples by using an arctangent approximation from an input signal; and eliminating a DC offset from the calculated phase difference, wherein the phase difference corresponds to the chrominance signal.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of an apparatus for recovering a SECAM chrominance signal according to an exemplary embodiment of the present invention;

FIG. 2 is a flowchart illustrating a method of recovering a SECAM chrominance signal according to an exemplary embodiment of the present invention;

FIGS. 3A and 3B are graphs illustrating a frequency response characteristic of a horizontal filter according to an exemplary embodiment of the present invention;

FIG. 4 is a graph illustrating a frequency response characteristic of a bell filter according to an exemplary embodiment of the present invention;

FIG. 5 illustrates a phase difference between samples using polar coordinates according to an exemplary embodiment of the present invention; and

FIG. 6 is a graph illustrating a frequency response characteristic of a de-emphasis filter according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

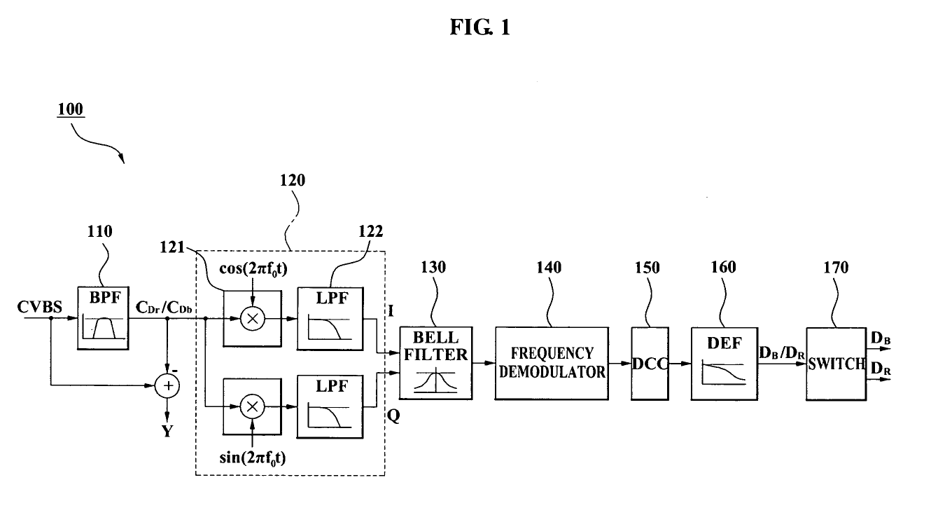

FIG. 1 is a block diagram illustrating a configuration of an apparatus 100 for recovering a sequential color with memory (SECAM) chrominance signal according to an exemplary embodiment of the present invention.

As shown in FIG. 1, the apparatus 100 for recovering a SECAM chrominance signal according to the present exemplary embodiment includes a band pass filter (BPF) 110, a frequency down-converter 120, a bell filter BCF 130, a frequency demodulator 140, a direct current (DC) compensation unit 150, a de-emphasis filter (DEF) 160, and a switch 170. In this instance, the frequency demodulator 140 calculates a phase difference between neighboring samples by using an arctangent approximation from an input signal.

The BPF 110 outputs a frequency modulated chrominance signal C_{Db} or C_{Dr} from an inputted composite video baseband signal (CVBS). In this instance, C_{Db} corresponds to a chrominance signal of a SECAM standard which includes blue color information, and C_{Dr} corresponds to a chrominance signal of the SECAM standard which includes red color information. While not included in the description of the present invention, when the chrominance signal C_{Db} or C_{Dr} is eliminated from the CVBS, a luminance signal Y may be outputted. The frequency down-converter 120 down-converts a frequency of the chrominance signal C_{Db} or C_{Dr}, which is outputted via the BPF 110, and thereby generates an in-phase (I) signal and a quadrature phase (Q) signal in a baseband. In this instance, the frequency down-converter 120 includes a multiplier 121 and a low pass filter (LPF) 122. The multiplier 121 multiplies the chrominance signal C_{Db} or C_{Dr}), which is separated via the BPF 110, with each of cos(2f₀t) and sin(2f₀t), and outputs results of the multiplications. Also, the LPF 122 eliminates a high frequency component of the signals, outputted via the multiplier 121, and thereby outputs the I signal and the Q signal in the baseband. In this instance, f₀ indicates a mean frequency, for example, 4.286 MHz, of the chrominance signal C_{Db} or C_{Dr}.

The bell filter 130 bell-filters each of the I signal and the Q signal which are generated via the frequency down-converter 120, and constantly envelopes the amplitude of the I signal and the Q signal and thereby outputs a single constant-enveloped signal.

The frequency demodulator 140 calculates a phase difference between neighboring samples by using an arctangent approximation from the signal outputted via the bell filter 130. Specifically, the frequency demodulator 140 calculates the chrominance signal C_{Db} or C_{Dr}.

The DC compensation unit 150 eliminates a DC offset from the chrominance signal C_{Db} or C_{Dr}, outputted via the frequency demodulator 140. Also, the DEF 160 de-emphasis filters the chrominance signal in which the DC offset is eliminated by the DC compensation unit 150, and also eliminates a high frequency component from the chrominance signal.

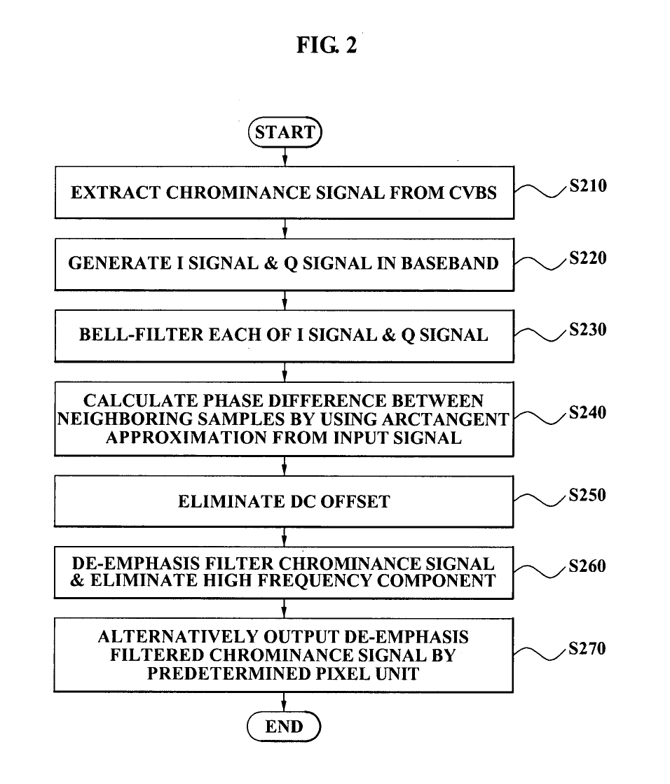

A method of recovering a SECAM chrominance signal according to an exemplary embodiment of the present invention, as constructed as described above, will be described with reference to FIG. 2.

FIG. 2 is a flowchart illustrating a method of recovering a SECAM chrominance signal according to an exemplary embodiment of the present invention.

As shown in FIG. 2, the method of recovering a SECAM chrominance signal according to the present exemplary embodiment includes operation S210 of extracting a frequency-modulated chrominance signal from an inputted CVBS; operation S220 of generating an I signal and a Q signal in a baseband; operation S230 of bell-filtering each of the I signal and the Q signal; operation S240 of calculating a phase difference between neighboring samples by using an arctangent approximation from an input signal; operation S250 of eliminating a DC offset; operation S260 of de-emphasis filtering the chrominance signal from which the DC offset is eliminated and thereby eliminating a high frequency component; and operation S270 of alternatively outputting the de-emphasis filtered chrominance signal by a predetermined pixel unit.

Hereinafter, the method of recovering the SECAM chrominance signal according to the present exemplary embodiment will be described in detail.

When a transmitting side transmits chrominance signals by using a SECAM scheme, the transmitting side performs a low frequency pre-emphasis with respect to a chrominance signal component D_{R} or D_{B} to be transmitted for improvement of a signal-to-noise ratio (SNR), via a low frequency pre-emphasis filter, which may be represented as

$$\begin{matrix}{D}_{R}^{*} = {A}_{BF} ( f ) {D}_{R} \\ {D}_{B}^{*} = {A}_{BF} ( f ) {D}_{B}\end{matrix} {A}_{BF} ( f ) = \frac{1 + j ( f / {f}_{1} )}{1 + j ( f / 3 {f}_{1} )} . \qquad [ Equation 1 ]$$

In this instance, f indicates an instantaneous subcarrier frequency, and f₁ indicates 85 KHz.

Also, the receiving side may acquire a frequency-modulated chrominance component by performing a frequency modulation with respect to signals acquired from Equation 1 above, and also performing a high frequency pre-emphasis via a high frequency pre-emphasis filter, for example, an anti-bell filter, which may be represented as

$$G ( f ) = {M}_{0} \frac{1 + j 16 F}{1 + j 1.26 F} , \\ F = \frac{f}{{f}_{0}} - \frac{{f}_{0}}{f} . \qquad [ Equation 2 ]$$

In this instance, f indicates an instantaneous subcarrier frequency, f₀ indicates 4.286 KHz, and M₀ indicates 23+/−2.5%.

A receiving side receives the SECAM CVBS, E_{M}. In this instance, the CVBS E_{M} may be represented as a luminous signal component E_{Y}′ and a frequency modulated chrominance signal component as shown in Equation 3 and Equation 4 below. Particularly, the chrominance signal components D_{R} and D_{B} alternatively utilize scanning lines and thus may be respectively represented as

E_{M}=E′_{Y}+G cos 2π(f′_{OR}t+Δf_{OR}∫₀D*_{R}(τ)dτ), and[Equation 3]

E_{M}=E′_{Y}+G cos 2π(f′_{OB}t+Δf_{OB}∫₀D*_{B}(τ)dτ). [Equation 4]

In this instance, f_{OR} indicates a subcarrier frequency of the chrominance signal component D_{R}, and Δf_{OR} indicates a frequency shift of the chrominance signal component D_{R}, D*_{R}(τ) indicates a low frequency pre-emphasis filtered chrominance signal component D_{R}, f_{OB} indicates a subcarrier frequency of the chrominance signal component D_{B}, and Δf_{OR} indicates a frequency shift of the chrominance signal component D_{B}, D*_{R}(τ) indicates a low frequency pre-emphasis filtered chrominance signal component D_{B}, and G indicates 23IRE/2. IRE indicates Institute of Radio Engineers, and is a unit to define a signal with a video size. 100IRE indicates a signal of 714 mV.

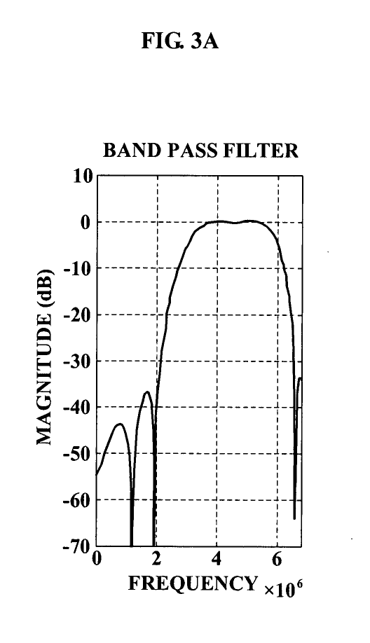

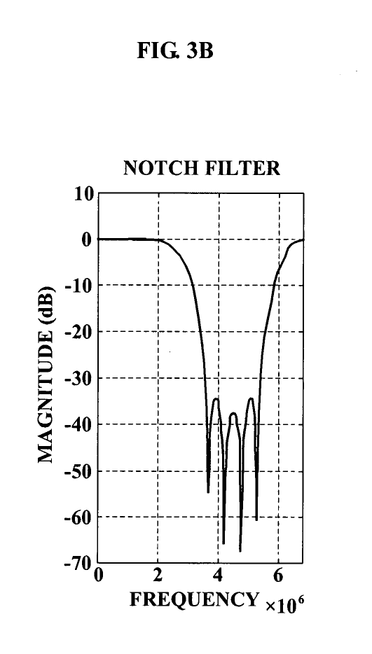

In operation S210, the BPF 100 may calculate the frequency modulated chrominance signal from the inputted CVBS E_{M}. Generally, in a SECAM scheme, a correlation between CVBS E_{M} and a neighboring line is comparatively low. Accordingly, the frequency modulated chrominance signal may be extracted using a horizontal filter, for example, the BPF 100 or a notch filter. Hereinafter, a frequency response characteristic of the horizontal filter will be described with reference to FIGS. 3A and 3B.

FIGS. 3A and 3B are graphs illustrating a frequency response characteristic of a horizontal filter according to an exemplary embodiment of the present invention.

As shown in FIGS. 3A and 3B, according to the frequency response characteristic of the horizontal filter, a BPF may be utilized to extract a chrominance signal from a CVBS E_{M}. Also, a notch filter may be utilized to extract a luminous signal from the CVBS E_{M}.

Chrominance signals C_{Dr} and C_{Db} of D_{R} and D_{B} lines, which are extracted via the BPF, are acquired through the same process, and thus only a process of acquiring the chrominance signal C_{Dr} of the D_{R} line will be described. In this instance, the chrominance signal C_{Dr} of the D_{R} line may be represented as

C_{Dr}=G cos 2π(f_{OR}t+Δf_{OR}∫₀D*_{R}dτ). [Equation 5]

When m(t) is defined as shown in Equation 6 below, Equation 5 above may be briefly represented as Equation 7 below.

m(t)=2πΔf_{OR}∫₀D*_{R}dτ [Equation 6]

C_{Dr}=G cos(2πf_{OR}t+m(t)) [Equation 7]

In operation S220, the frequency down-coveter 120 down-converts the frequency of the extracted chrominance signal C_{Dr}, and thereby generates the I signal and the Q signal in the baseband. In this instance, the frequency down-converter 120 includes the multiplier 121 and the LPF 122 as shown in FIG. 1. Accordingly, signals C_{cdr} and C_{sdr}, which are acquired by multiplying cos(2f₀t) and sin(2f₀t) with the chrominance signal C_{Dr} via the multiplier 121, may be respectively represented as

$$\begin{matrix}\begin{matrix}{C}_{cdr} = {C}_{Dr} \times cos ( 2 π {f}_{0} t ) \\ = \frac{G}{2} [ \begin{matrix}cos ( 2 π {f}_{0} t + 2 π {f}_{OR} t + m ( t ) ) + \\ cos ( 2 π {f}_{0} t - 2 π {f}_{OR} t + m ( t ) )\end{matrix} ] , and\end{matrix} & [ Equation 8 ] \\ \begin{matrix}{C}_{sdr} = {C}_{Dr} \times sin ( 2 π {f}_{0} t ) \\ = \frac{G}{2} [ \begin{matrix}sin ( 2 π {f}_{0} t + 2 π {f}_{OR} t + m ( t ) ) + \\ sin ( 2 π {f}_{0} t - 2 π {f}_{OR} t + m ( t ) )\end{matrix} ] .\end{matrix} & [ Equation 9 ]\end{matrix}$$

In order to eliminate the high frequency components of signals outputted via the multiplier 121, the LPF 122 outputs baseband signals, that is, the I signal and the Q signal, which may be respectively represented as

$$\begin{matrix}\begin{matrix}I = \frac{G}{2} {C}_{r} ( t ) \\ = LPF ( {C}_{cdr} ) \\ = \frac{G}{2} cos ( 2 π ( {f}_{0} - {f}_{OR} ) t + m ( t ) ) ,\end{matrix} \\ and & [ Equation 10 ] \\ \begin{matrix}Q = \frac{G}{2} {C}_{i} ( t ) \\ = LPF ( {C}_{sdr} ) \\ = \frac{G}{2} sin ( 2 π ( {f}_{0} - {f}_{OR} ) t + m ( t ) ) .\end{matrix} & [ Equation 11 ]\end{matrix}$$

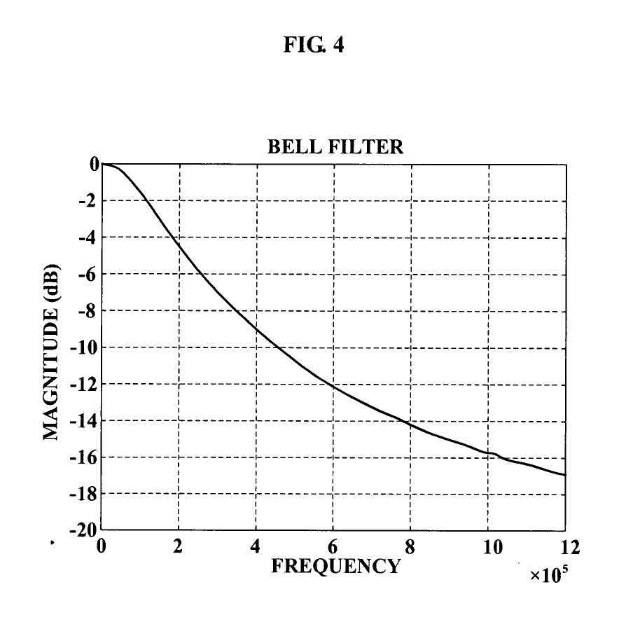

The bell filter 130 performs an inverse process of the high frequency pre-emphasis filter of the transmitting side. In this instance, the bell filter 130 is referred to as a cloche filter. In operation S230, the bell filter 130 bell-filters each of the I signal and the Q signal which are generated via the frequency down-converter 120, and constantly envelopes the amplitude of the I signal and the Q signal and thereby outputs a single constant-enveloped signal. Hereinafter, the frequency response characteristic of the bell filter 130 will be described with reference to FIG. 4.

FIG. 4 is a graph illustrating a frequency response characteristic of a bell filter according to an exemplary embodiment of the present invention.

As shown in FIG. 4, in operation S230, the bell filter 130 may eliminate a gain component, G/2, from the I signal and the Q signal acquired from the above Equation 10 and Equation 11, respectively, based on the frequency response characteristic of the bell filter 130 according to the present exemplary embodiment.

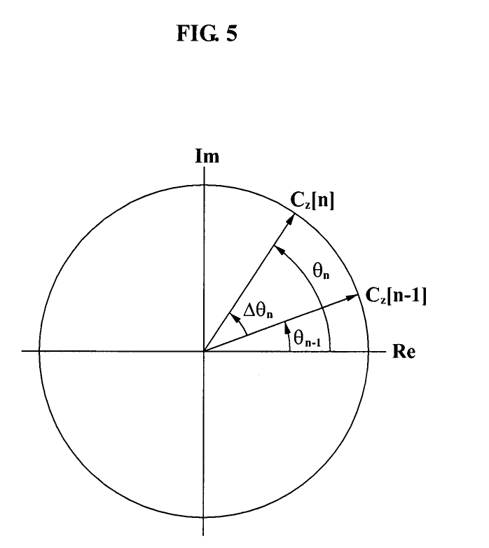

In operation S240, the frequency demodulator 140 calculates the phase difference between the neighboring samples by using the arctangent approximation with respect to the bell-filtered signal. Also, the frequency demodulator may include a phase differentiator and a phase estimator. The phase differentiator calculates a phase difference component between the neighboring samples, based on multiplication of a first sample and a conjugate complex number of a second sample. In this instance, the first sample and the second sample correspond to the neighboring samples, and the second sample delays the first sample. Also, the phase estimator calculates the phase difference between the neighboring samples by using the arctangent approximation, based on the calculated phase difference component. A method of calculating the phase difference may include a method of using polar coordinates, which will be described with reference to FIG. 5.

FIG. 5 illustrates a phase difference between samples using polar coordinates according to an exemplary embodiment of the present invention.

As shown in FIG. 5, when information between neighboring samples according to the present exemplary embodiment are indicated as C_{z}[n] and C_{z}[n−1], they may be represented as complex numbers given by

C_{z}[n]=e^{jθ}^{ₙ}

C_{z}[n−1]=e^{jθ}^{ₙ₋₁}. [Equation 12]

Also, based on C_{z}[n] and C_{z}[n−1], the phase difference component may be indicated as the complex number given by

e^{jΔθ}^{ₙ}=e^{j(θ}^{ₙ}^{-θ}^{ₙ₋₁}⁾=cos(θₙ−θₙ₋₁)+j sin(θₙ−θₙ₋₁). [Equation 13]

When a real number portion and an imaginary number portion of the phase difference component are separated from the above Equation 13 indicated as the complex number, the real number portion and the imaginary number portion may be respectively represented as

R_{z}=Rₑ{e^{jΔθ}^{_{N}}}=cos(θ_{N}−θ_{N-1}),

I_{z}=Im{e^{jΔθ}_{N}}=cos(θ_{N}−θ_{N-1}). [Equation 14]

Also, in order to acquire the phase difference Δθₙ, Equation 15 and Equation 16 below may be represented by using the real number portion and the imaginary portion.

$$\begin{matrix}\frac{{I}_{z}}{{R}_{z}} = \frac{sin ( {θ}_{n} - {θ}_{n - 1} )}{cos ( {θ}_{n} - {θ}_{n - 1} )} = tan ( {θ}_{n} - {θ}_{n - 1} ) & [ Equation 15 ] \\ Δ {θ}_{n} = {θ}_{n} - {θ}_{n - 1} = arctan ( \frac{{I}_{z}}{{R}_{z}} ) & [ Equation 16 ]\end{matrix}$$

In this instance, θₙ indicates phase information of the above Equation 10 and Equation 11, and may be given by

θₙ2π(f₀−f_{OR})n+m[n]. [Equation 17]

When the above Equation 17 is arranged, the phase difference Δθₙ may be represented as

Δθₙ=θ_{n-θ}ₙ₋₁=2π(f₀−f_{OR})+m[n]−m[n−1] [symbol] m[n]−m[n−1]=Δθₙ−2π(f₀−f_{OR}) [Equation 18]

From the above Equation 6, the chrominance signal corresponding to an original signal may be represented as

$$m ( t ) = 2 π Δ {f}_{OR} {\int }_{0}^{t} {D}_{R}^{*} d t \\ ⇒ {D}_{R}^{*} [ n ] = \frac{1}{2 πΔ {f}_{OR}} ( m [ n ] - m [ n - 1 ] ) . \qquad [ Equation 19 ]$$

When the above Equation 18 is substituted for the above Equation 19, it may be represented as

$${D}_{R}^{*} [ n ] = \frac{1}{2 πΔ {f}_{OR}} ( Δ {θ}_{n} - 2 π ( {f}_{0} - {f}_{OR} ) ) . \qquad [ Equation 20 ]$$

When the phase difference Δθₙ is acquired, the frequency modulated chrominance signal D_{R}*[n] can be acquired.

In this instance, an arctangent needs to be calculated to acquire the phase difference Δθₙ. In an exemplary embodiment of the present invention, the arctangent approximation is utilized. When utilizing the arctangent approximation, the phase difference Δθₙ may be represented as Equation 21 below. Specifically, in comparison to a generally sampling frequency, the chrominance signal has a significantly low frequency component. Specifically, in the above Equation 15, the size of I_{z}/R_{z} is too small and thus an arctan (I_{z}/R_{z}) value exists in a linear portion and the arctangent approximation may be utilized.

$${Δθ}_{n} = arctan ( \frac{{I}_{z}}{{R}_{z}} ) \approx \frac{{I}_{z}}{{R}_{z}} \qquad [ Equation 21 ]$$

Due to the arctangent approximation, the phase difference may be acquired by using only a divide operation. The arctangent approximation may avoid a floating point operation which it is relatively difficult to readily realize in hardware, and may perform a fixed-point operation which it is relatively simple to realize in hardware.

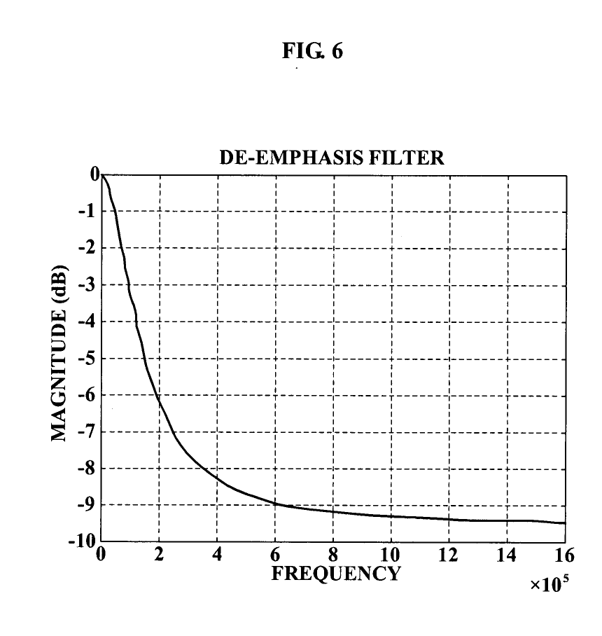

In operation S250, the DC compensation unit 150 eliminates the DC offset from the calculated phase difference. In operation S260, the DEF 160 performs the inverse process of the low frequency pre-emphasis filter of the transmitting side, and eliminates the high frequency component from the signal in which the DC offset is eliminated by the DC compensation unit 150 Hereinafter, the frequency response characteristic of the DEF 160 will be described with reference to FIG. 6.

FIG. 6 is a graph illustrating a frequency response characteristic of a de-emphasis filter according to an exemplary embodiment of the present invention.

As shown in FIG. 6, based on the frequency response characteristic of the DEF 160 according to the present exemplary embodiment of the present invention, the DEF 160 outputs the original chrominance signal D_{R} by eliminating the high frequency component from the signal in which the DC offset is eliminated by the DC compensation unit 150. In this instance, the original chrominance signal D_{R} may be represented as

D_{R}=A_{BF}⁻¹=(f)D*_{R}. [Equation 22]

Consequently, the switch 170 includes a separate line buffer to alternatively output the chrominance signal by a predetermined pixel unit, for example, by one pixel unit, so that chrominance signals of D_{R} and D_{B} lines may be simultaneously provided by each line unit. In this instance, a cross-over switch may be utilized for the switch 170.

The chrominance signal recovering method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the present invention, there is provided an apparatus and method of recovering a SECAM chrominance signal which can utilize both a real number portion and an imaginary number portion to recover a chrominance signal, and calculate a phase difference using an arctangent approximation and thus can simplify a phase difference calculation scheme and also simplify a circuit configuration of a frequency demodulator.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for recovering a chrominance signal from a composite video baseband signal (CVBS), the apparatus comprising:
a frequency demodulator calculating a phase difference between neighboring samples by using an arctangent approximation from an input signal; and
a direct current (DC) compensation unit eliminating a DC offset from the calculated phase difference,
wherein the phase difference corresponds to the chrominance signal.

2. The apparatus of claim 1, wherein the phase difference is calculated by dividing an imaginary number portion of a phase difference component between the neighboring samples by a real number portion of the phase difference component.

3. The apparatus of claim 1, wherein:
the phase difference is calculated based on multiplication of a first sample and a conjugate complex number of a second sample wherein the second sample delays the first sample, and
the first sample and the second sample correspond to the neighboring samples.

4. The apparatus of claim 1, further comprising:
a band pass filter (BPF) extracting the chrominance signal from the CVBS;
a frequency down-converter down-converting a frequency of the extracted chrominance signal and generating an in-phase (I) signal and a quadrature-phase (Q) signal in a baseband; and
a bell filter bell-filtering each of the I signal and the Q signal, and outputting each of the bell-filtered I signal and the Q signal to the frequency demodulator as the input signal.

5. The apparatus of claim 1, further comprising:
a de-emphasis filter (DEF) de-emphasis filtering the chrominance signal and eliminating a high frequency component from the chrominance signal in which the DC offset is eliminated; and
a switch alternatively outputting the de-emphasis filtered chrominance signal by a predetermined pixel unit.

6. The apparatus of claim 1, wherein the chrominance signal is based on a sequential color with memory (SECAM) scheme.

7. A method of recovering a chrominance signal from a CVBS, the method comprising:
calculating a phase difference between neighboring samples by using an arctangent approximation from an input signal; and
eliminating a DC offset from the calculated phase difference,
wherein the phase difference corresponds to the chrominance signal.

8. The method of claim 7, wherein the phase difference is calculated by dividing an imaginary number portion of a phase difference component between the neighboring samples by a real number portion of the phase difference component.

9. The method of claim 7, wherein:
the phase difference is calculated based on multiplication of a first sample and a conjugate complex number of a second sample wherein the second sample delays the first sample, and
the first sample and the second sample correspond to the neighboring samples.

10. The method of claim 7, further comprising:
extracting the chrominance signal from the CVBS;
down-converting a frequency of the extracted chrominance signal and generating an I signal and a Q signal in a baseband; and
bell-filtering each of the I signal and the Q signal, and outputting each of the bell-filtered I signal and the Q signal to the frequency demodulator as the input signal.

11. The method of claim 7, further comprising:
de-emphasis filtering the chrominance signal and eliminating a high frequency component from the chrominance signal in which the DC offset is eliminated; and
alternatively outputting the de-emphasis filtered chrominance signal by a predetermined pixel unit.

12. The method of claim 7, wherein the chrominance signal is based on a SECAM scheme.

13. A computer-readable recording medium storing a program for implementing the method of claim 7.
